(19) United States
(12) Patent Application Publication
(10) Pub. No.: US 2013/0188764 A1
(43) Pub. Date: Jul. 25, 2013

(54) SYSTEMS AND METHODS FOR GENERATING ELECTRON SPIRAL TOROIDS

(71) Applicant: Clint Seward, Acton, MA (US)

(72) Inventor: Clint Seward, Acton, MA (US)

(21) Appl. No.: 13/737,519

(22) Filed: Jan. 9, 2013

Related U.S. Application Data
(60) Provisional application No. 61/710,417, filed on Oct. 5, 2012.
(60) Provisional application No. 61/631,733, filed on Jan. 10, 2012.

(51) Int. Cl. H05H 1/50

(52) U.S. Cl. CPC H05H 1/50
USPC 376/145

(57) ABSTRACT

A spheromak is a plasma of ions and electrons formed into a toroidal shape. A spheromak plasma can include electrons and ions of nearly equal amounts such that it is essentially charge neutral. It contains large internal electrical currents and their associated internal magnetic fields arranged so that the forces within the spheromak are nearly balanced. The spheromak described herein is observed to form around an electric arc in partial atmosphere, and is observed to be self-stable with no external magnetic containment.

### CROSS REFERENCE TO RELATED APPLICATION

The present application claims priority to U.S. application No. 61/631,733 filed Jan. 10, 2012 and also claims priority to U.S. application No. 61/710,417 filed on Oct. 5, 2012, the entire contents of these applications being incorporated herein by reference.

### BACKGROUND OF THE INVENTION

A spheromak can be defined as a toroidal shaped arrangement of plasma consisting of electrons and ions. Traditional spheromaks contain large internal electrical currents and their associated magnetic fields are arranged so the forces within the spheromak are nearly balanced, resulting in confinement times of about a few microseconds without any external fields.

Spheromaks can be generated using a “gun” type device that ejects spheromaks off the end of an electrode into a holding area called a flux conserver. This has made them useful in the laboratory setting for analysis, and spheromak guns are relatively common in astrophysics laboratories. Spheromaks have also been observed to occur in nature as a variety of astrophysical events, like coronal loops and filaments, relativistic jets and plasmoids.

Spheromaks have been proposed as a magnetic fusion energy concept due to their confinement times, on the order of a few microseconds, which was on the same order as the best

Tokamaks when they were first being studied in the mid-twentieth century. Though they had some successes, these small and lower-energy devices had limited performance.

It has been demonstrated that hotter spheromaks have better confinement times, and this has led to a second wave of spheromak machines. Spheromaks have also been used as a mean of injecting plasma into a bigger magnetic confinement experiment like a Tokamak. However, there remains a significant need for improvements in the generation of stable toroidal shaped particle assemblies for a variety of applications.

### SUMMARY OF THE INVENTION

The present invention relates to systems and methods for generating electron toroids. This is formed in partial or full atmosphere where it is observed to remain stable for hundreds of milliseconds with no external magnetic field for confinement. The charged particles in this spheromak produce a strong internal magnetic field. A spiraling path for the electrons in the surface of the spheromak produces a large internal magnetic field, hence the name of this type of spheromak: the Electron Spiral Toroid Spheromak (ESTS).

A preferred embodiment of the present invention provides a moving electrode system to initiate an ESTS. One or more electrodes can undergo controlled translation using a programmable control system. A computer can be programmed using software configured to control a data processor or microcontroller to transmit control signals to an actuator that enables motion of the electrodes and to adjust parameters used to form the toroid. The initiating voltage and the current across the arc formed between the electrodes are parameters selectable by the user to control formation and movement. A camera and system sensors can be used to provide feedback control of toroid formation.

This spheromak, the ESTS, is formed using a high current electric arc. The arc is preferably formed in partial atmosphere, and the ESTS is formed around the arc. Instead of forming spheromaks in high vacuum, preferred embodiments of the present invention form them in partial to full atmosphere. The ESTS formed in this manner is observed to remain in place around the arc for the duration of the arc, which has been observed for hundreds of milliseconds.

ESTSs have also been observed to pass through the arc and leave it entirely. When an ESTS leaves the arc, it passes through the magnetic fields of the arc while maintaining ESTS stability and shape. It is observed to remain stable after it is removed from the arc, with no external magnetic field for confinement, and spins at a high rate. High speed cameras have demonstrated that the shape is that of a spheromak by capturing images at a very fast shutter speed, fast enough to capture the ESTS image in mid spin. Also, in cases where the ESTS is removed from the arc, it is observed to endure for hundreds of milliseconds, for example, and can be moved by applying a directed magnetic field.

In a preferred embodiment of the ESTS, the invention provides a class of spheromak that is formed in partial atmosphere in contrast to formation in a high vacuum. This class of spheromak is formed around an electric arc. The spheromak is observed to endure for many milliseconds, a longer time than the tens of microseconds of traditional spheromaks when no external confining magnetic field is used.

In addition to describing the ESTS, described herein is a system for accelerating the ESTS once it has been formed. This enables a user to add energy to the ESTS. The accelerated ESTS has several applications including x-ray generation, particle beam accelerator, or an improved colliding spheromak energy generator.

### BRIEF DESCRIPTION OF THE DRAWINGS

FIGS. 1A-1B are schematic views of a preferred embodiment of the Electron Spiral Toroid Spheromak (ESTS) invention showing an ESTS formed around an initiating arc.

FIG. 2 is a schematic view of the apparatus used to produce the Electron Spiral Toroid Spheromak with a moving frame used to separate the electrodes.

FIG. 3 is a schematic view of the apparatus used to produce the Electron Spiral Toroid Spheromak with a screw motor used to move the electrodes in place of the moving frame.

FIG. 4 is a schematic view of the apparatus used to produce the Electron Spiral Toroid Spheromak with a laser used to initiate the arc instead of the moving electrodes.

FIG. 5 is a schematic of the Electron Spiral Toroid Spheromak.

FIG. 6 is a simplified schematic view of an Electron Spiral Toroid Spheromak accelerator.

FIG. 7 is a more detailed view of an Electron Spiral Toroid Spheromak accelerator.

FIG. 8 is a process sequence for controlling formation of a toroid using a control system.

### DETAILED DESCRIPTION OF THE INVENTION

A spheromak is a toroidal shaped arrangement of plasma consisting of electrons and ions. A typical spheromak has a toroid shape in a three-dimensional configuration. Additional details regarding prior systems for producing electron toroids can be found in U.S. Pat. No. 6,603,247, the entire contents of which is incorporated herein by reference.

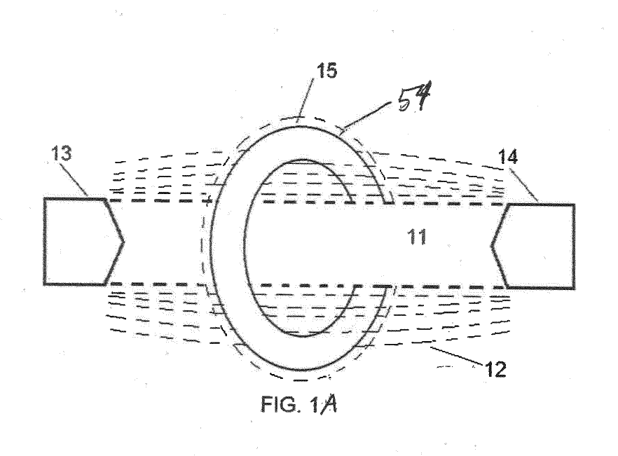

Shown in FIG. 1A is a schematic diagram of a view of a preferred embodiment of the invention. The elements required to initiate an Electron Spiral Toroid Spheromak (ESTS) are an electric arc 11, between an anode 13 and a cathode 14. The arc is formed in partial or full atmosphere in a chamber. Collisions of the arc electrons with the background gas create ions 12. When the operating parameters are correct, such as voltage, pressure, arc distance and speed of the moving electrodes, an ESTS 15 forms within the chamber.

The methods for forming an electric arc suitable for formation of an ESTS require stability and duration. The arc must be stable for a period of time, compared to arcs that are often unstable in the sense that they change arc paths rapidly and often.

The arc current value is also important. For arcs of approximately five to eight centimeters of arc length, for example, the current is found to range from 200 to 600 amperes. At this value, the arc has an essentially uniform external magnetic field. As electrons leave the arc, they are acted on by the arc magnetic field which causes them to assume a toroidal orbit around the arc. When enough electrons have left the arc, they produce the ESTS. It is important to note that the arc channel itself must be narrower than the path of the electrons around the arc such that the electrons leave the arc that do not collide with the particles remaining in the arc itself.

Positively charged ions from around the arc are trapped within or around the ESTS surface during formation. These ions serve to electrically neutralize the toroid within the housing. As shown in FIG. 1B, electrons leave the arc substantially simultaneously and curl around in response to the magnetic field to form the toroid. The ions situated within the toroid 52 or outside the toroid 54 can form boundary layers with a charge gradient operative to dynamically neutralize a region or envelope around the toroid.

There is a critical point in toroid formation at which the electron velocity within the arc is sufficient and the arc current decreases when field conditions enable toroid formation. With a capacitor system power supply, the voltage across the arc can drop as the arc draws power which results in a decrease in the current. This is coordinated with the increasing distance between the electrodes which increases the resistance between the electrodes. Because the current decreases faster than the decrease in electron velocity, for example, this can enable toroid formation. More specifically, when the electrodes are employed for initiation in which they are initially touching, the circuit resistance is at its lowest value. At this time, the capacitor power supply can provide a maximum voltage and current when fully charged and can potentially damage the electrodes, for example. To mitigate or eliminate this possibility, a variable resistor or other voltage control device can be used to adjust the initial voltage and current to control the arc and further control initiation of one or more toroids with the arc. In a preferred method, the initial voltage at contact is increased for a first time period upon electrode separation for about 100 milliseconds, for example. However, as the electrode separation increases and more gas particles enter the electrode gap, the resistance in the gap increases causing a reduction in the voltage (and current) across the gap, assuming that the voltage is not increased further by the voltage controller. The exact voltage and current for toroid formation will vary as a function of system resistance, electrode materials, gas pressure, arc gap length and power supply characteristics. In a preferred method, the invention includes a process for generating a plurality of toroids using a single arc sequence. In this embodiment, after formation of a first toroid as described above, the voltage/current across the arc can be reduced to a level that allows the first toroid to be released from the arc. However, the residual arc ions remain in place long enough, even if the arc is temporarily disrupted, for up to a few hundred milliseconds. This enables the system to then increase the voltage/current and reestablish the arc to enable repetitive formation of a plurality of toroids in sequence.

Note that the ESTS has an essentially uniform geometry, that is, the charged particle orbits within the ESTS are nearly the same at all points of the ESTS. This occurs when enough electrons leave the arc and form the essential toroid shape that they in turn create their own magnetic field internal to the ESTS. When this state is reached, then the internal fields in the ESTS ensure that the radius of each orbit is essentially the same for all orbits. At this point the ESTS is stable and is self-organized (that is, confined without an external magnetic field) as described by Chen, C., Pakter, R., Seward, C. in “Equilibrium and Stability Properties of Self-Organized Electron Spiral Toroids,” Physics of Plasmas, Vol. 8, No. 10, 2001, the entire contents of which is incorporated herein by reference. It is also observed to endure in partial atmosphere for hundreds of milliseconds, and as the energy level of the toroid increase, the toroid can endure for minutes. Ions from around the arc are trapped within ESTS surface during formation when the electrons leave the arc and move into the toroid shape, positively charged ions are entrained with the toroid surface.

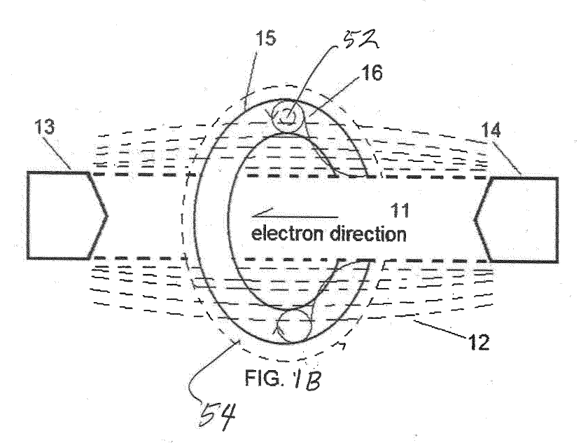

FIG. 2 is a schematic of the initiating apparatus for the ESTS. ESTS formation takes place in a significant atmosphere of background gas, from partial to full atmosphere. The methods for obtaining a partial vacuum are well known such as forming the partial vacuum in a bell jar 26 or other vacuum chamber evacuated using a vacuum pump 90. This operating region can be backfilled with nitrogen to the appropriate pressure. ESTSs forming in pressures from one Torr to 300 Torr were observed, but they can form in higher pressures up to one atmosphere and even higher with selected changes in voltage and spacing.

The electric arc used is formed with electrodes 13 and 14. The arc is formed by first placing the electrodes together then applying voltage enough to maintain the arc across the gap as it is drawn. The electrodes are then drawn apart using the moving frame 16 until the full arc gap is opened, with just the anode on the moving frame, while the cathode is on the fixed frame 19. A motor 17 is used to pull apart the electrodes using a series of simple pulleys 18 and a cable. The fixed frame 19 holds in place the motor, pulleys, and cathode. During the arc drawing process, the arc current can be increased to higher levels which might be harmful to the electrodes when they are touching, but act to increase the arc current later in the process.

Initially, exploding wires were used to generate the arcs. However, the exploding wire needs to be replaced after each event, making difficult ESTS applications which utilize many ESTSs formed in rapid fashion, while the drawn arc approach described herein uses the same electrodes for many arc events. The exploding wires leave a residue which needs to be cleaned and removed after each arc event. Thus the drawn arc system is more useful and efficient for repeated arc formation.

The voltage required across the arc gap is dependent on the gap length, the background gas pressure, and the material used in the electrodes. For a gap length of 8.5 cm, for example, voltages of 110 VDC to 125 VDC have been shown to produce ESTSs in various pressures. Lower background gas pressures require lower voltages since it is easier to maintain an arc across a gap at lower pressures. Higher voltages have been used also, and there is no upper voltage limit, but as a rule, the voltage has to be low enough to allow electrons to escape the arc.

An electron gun can be used in place of electrodes, except that current electron guns used to produce electron beams do not have the current capability of arcs. Electron guns from Kimball Physics, for example, normally provide maximum currents in the tens of milliamperes range, well below the range needed for ESTS formation. The arcs used in this invention range from a few tens of amperes to thousands of amperes. FIG. 2 shows the power supply, 21, which comprises a capacitor bank. Batteries can be used, as well as other appropriate power supplies. For a preferred embodiment, the arcs range from 200 to 600 amperes, but with specific design requirements, a wide range of currents can be utilized, allowing one to configure the ESTS to fit many applications. To control the current, a variable resistor 91, or similar current limiting device can be placed at the capacitor output.

For the preferred embodiment, the pressure used is preferably about ⅛^{th} atmosphere. The pressure can vary greatly and ESTSs have been observed from 0.10% atmosphere to 36% atmosphere with adjustment of system parameters. The lower limit is the density of the background gas as there must be enough gas molecules to form sufficient ions to neutralize the electron charge.

For a preferred embodiment, the background gas is normally nitrogen since it is easy to obtain and will not react with the electrodes as they become heated during arc formation. Other inert gases can be used, and argon and helium have been used, for example. Air can be utilized, although it can be harmful to the electrodes since the oxygen can rapidly react with the heated electrodes. Hydrogen can be used, but care must be taken to provide for safety by ensuring that oxygen is not mixed with the hydrogen.

Referring again to FIG. 2, the control panel or processor for the arc apparatus is shown schematically as 25, which control panel starts the apparatus by first actuating the contactors 22 and 23 when the electrodes are touching in order to heat the electrodes and to initiate the current. Power is applied to the electrodes using the cables 20 and 24. The controller 25 then actuates the motor to draw the anode 13 and, when conditions are correct, to form the arc and draw it the full length of the arc gap.

There is a limit to how fast an arc can be drawn. If drawn too fast, the arc will extinguish because it will not maintain the arc path. It is desirable to draw fast enough that the ESTS initiates before the capacitor supply discharges enough energy to drop below an output voltage that maintains the arc. Preferably, a draw of 8.5 cm in 0.45 seconds, or about 19 cm/second can be used, however, this value can vary range from 10-50 cm/second.

In one embodiment, the ESTS remains in place as long as the arc remains, which is controlled by the control circuit. In a second embodiment, the ESTS is observed to become self-stable independent of the arc. As the ESTS remains in place, under the right conditions it is observed to increase in density with time. When the ESTS becomes dense enough it is observed to move through the arc and become self-stable in the partial atmosphere. The necessary condition for this to happen is for the internal magnetic field of the ESTS to be greater than the arc magnetic field itself such that the ESTS can cross the magnetic field lines while maintaining its toroidal shape. To calculate the magnetic field of the arc and the ESTS internal magnetic field, the arc magnetic field is Ba=μ*Ia/2π*Ra, where Ia is the arc current, and Ra is the arc radius. For a typical experiment, with Ia=330 amperes, and Ra=0.0069m, Ba=0.0097 Tesla.

The ESTS is observed to pass through this field while remaining stable and to do so the ESTS internal magnetic field must be greater than the field of the arc by an approximate order of magnitude (ten times). The ESTS internal magnetic field Bt=Ns*μ*It/2π*Rt, where Ns is the number of electron shells in the ESTS surface, It is the toroidal current in a shell, and Rt is the ESTS radius. For a typical measurement where the ESTS is observed to cross the magnetic field lines of the arc, it is estimated that Ns=25, Is=10,400 A; Rt=0.0137 m resulting in Bt=3.8Tesla, which is greater than the arc magnetic field.

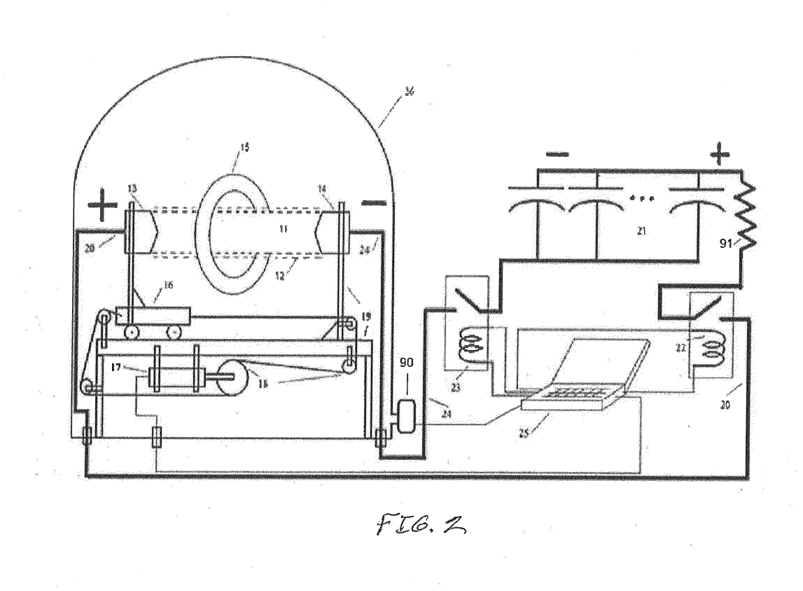

FIG. 3 shows a further improvement to the apparatus for drawing the arc. In this embodiment the moving frame and motor used to draw the arc are replaced by a simple screw and motor arrangement to move an electrode. Referring to FIG. 3, the anode is mounted to a moving frame 30. The moving frame is attached to a long screw 31 that is turned directly by a motor 32. As the motor is made to turn in one direction, it moves the moving frame away from the motor, thus drawing the arc. Similarly, as the motor is made to turn in the opposite direction, it moves the moving frame toward the motor and thus makes the electrodes touch in order to start another arc event. On the moving frame are shown wheels 33 used to maintain the orientation of the moving frame such that it remains level as the screw turns. Note that metal features are shielded from the arc in order to prevent the arc from finding an unintended ground and jumping from its intended arc path.

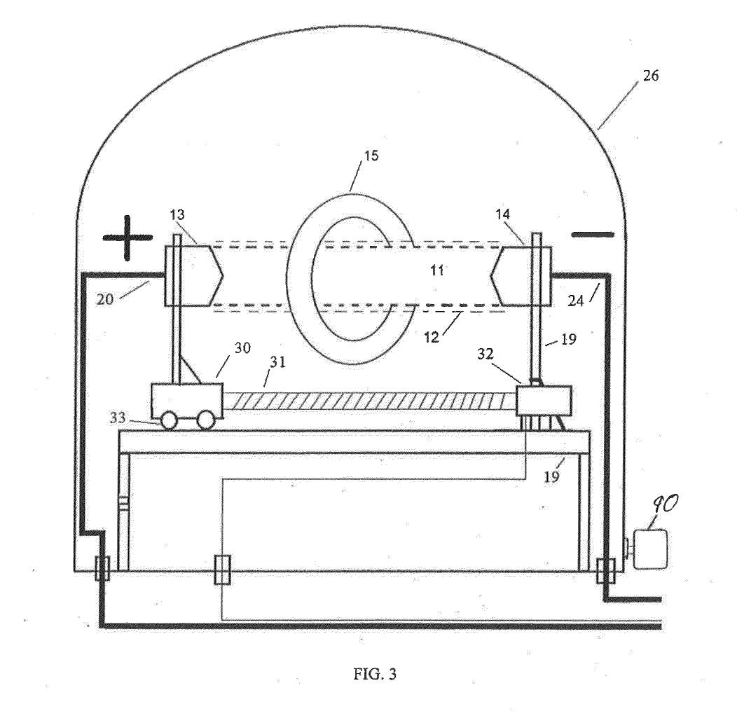

FIG. 4 shows a further improvement to the apparatus for drawing the arc. In this embodiment, the moving frame and motor used to draw the arc are replaced by a stationary laser that is used to ionize the background gas so as to establish an ion path from anode to cathode, which causes the voltage between electrodes to establish a current path and therefore an arc between the electrodes. Referring to FIG. 4, the anode is mounted to the stationary frame 19. A laser generator 40 is attached to the stationary frame such that its laser path 41 will travel through the cathode 14 and then through the anode 13 to hit the laser target 42. Note that the electrodes each have a hole through their center 43 to allow the laser to pass through. The laser causes the background gas to ionize and in so doing, allows the electric arc to form without the need for drawing the arc. Note that the laser generator and laser target must each be insulated from the anode and cathode in order to prevent the arc from finding them as an unintended ground and jumping from its intended arc path.

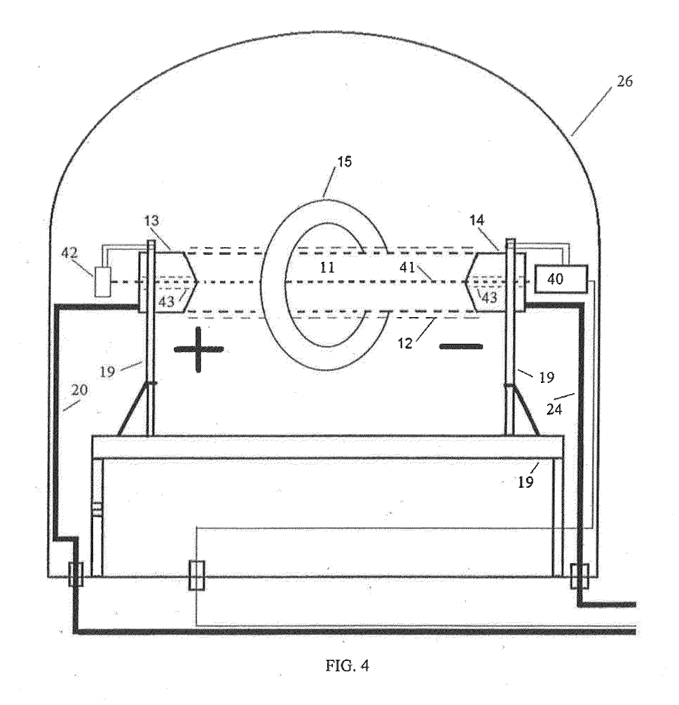

FIG. 5 is a schematic view of the ESTS 50 as a stand-alone entity. It shows the typical toroidal shape of the spheromak, and the hollow center of the ESTS. The internal magnetic field is shown as B. The radius of the orbit of the charged particles is r_{T} and is essentially uniform for all charged particle orbits. The radius of the ESTS is r_{T} and is essentially uniform for the entire ESTS. The electron shell is shown in a dotted manner as the outer shell. The spiraling of the electrons is shown by the parallel arrows, showing that the electron paths are parallel as the electrons spiral around the toroid. Also shown schematically is a continuous shell, representing the internal ions that neutralize the electron space charge, noting that external ions are observed as well, and can contribute to neutralizing the space charge. Calculations show that the model supports many shells of electrons and shells of ions. Also shown is the external magnetic field of the ESTS, labeled Bx, which results from the current caused by the spiraling motion of the charged particles in the ESTS. This external magnetic field is much less in magnitude compared to the internal magnetic field, but is important because it allows the ESTS to be transported and accelerated.

With this level of detail visible it is important to point out that during the initiation of the ESTS as shown in FIG. 1, the radius of the ESTS is greater than the radius of the initiating arc by an amount such that the orbit radius of the particles does not collide with the arc itself. This is helped by the background gas which acts to produce a narrow arc channel.

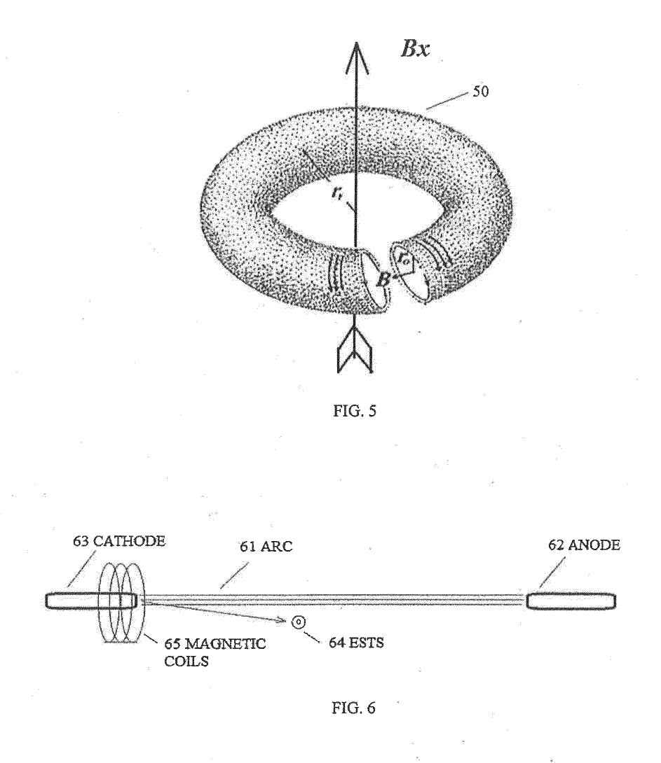

FIG. 6 is a simplified schematic diagram of an accelerator for the ESTS. The system enables small ESTSs in arcs that moved in random directions along the arc path or out of the arc path. Measurements and analysis have showed that they were self-organized and stable as described above and in the references, and that they could pass through the magnetic fields of the arc while retaining their shape. They are typically of small diameter of 0.2 cm to 0.5 cm. They were observed to form directly at the cathode or sometimes at the anode. Their size is consistent with the hot spots which form on the anode or cathode and from which the arc is seen to emanate. An electric arc consists of an accumulation of small arcs that form at individual hot spots, which explains how small ESTSs form during a larger arc event.

Further measurements demonstrated that these small ESTSs can be accelerated using magnetic coils. FIG. 6 shows the arc 61 formed between an anode 62 and a cathode 63. Under the right conditions of pressure, voltage, and current, many small ESTSs 64 were observed. When magnetic coils 65 were added and energized, the ESTSs were observed to accelerate. When accelerating the ESTS, care must be taken to keep the accelerating magnetic field below the level of the internal magnetic field of the ESTS or else the ESTS itself will lose its shape and stability, and can dissipate.

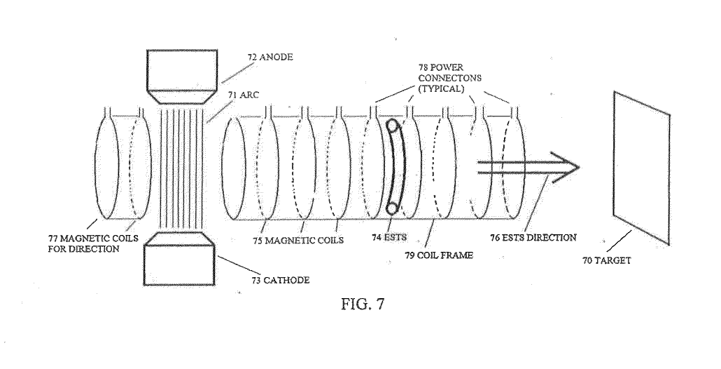

FIG. 7 illustrates that the ESTS is formed by an arc 71 formed between the anode 72 and the cathode 73. As described above, the ESTS 74 forms under appropriate conditions of voltage, current and pressure. Magnetic coils 75 accelerate the ESTS in the direction shown 76 when energized with a selected current. Magnetic coils for direction are shown as 77 to direct ESTSs once they are formed in the arc. Power is connected to individual coils of the magnet coil assembly with power connections 78. A frame 79 for holding the coils in place that can optionally be located inside the coils and made of a material such as ceramic which will help to guide the ESTS during its acceleration. A target, shown as 70, has various purposes depending on the application. The power supply for the coils and the control circuits to turn the coils on in succession to accelerate the ESTS are also known.

The basic equations for a solenoid magnetic field accelerator of an electron spiral toroid spheromak using an applied magnetic field pulse are presented here. Measurements have shown that when a static magnetic field is applied, accelerations of the ESTSs up 6000 m/s² have been observed. The theory of self-organized ESTSs has been developed to describe the confinement and stability of self-organized EST's.

Consider the magnetic coil ESTS accelerator shown schematically in FIG. 7. For simplicity, let us make the following assumptions:

(a) The power supply is characterized by its capacitance C and inductance L.

(b) The solenoid wires are perfect conductors.

(c) The ESTS internal magnetic (self-magnetic) field is much greater than and orthogonal to the applied magnetic field produced by the solenoid.

(d) The EST has such a high conductivity that it shorts the circuit.

Under these assumptions, the entire system can be treated as a circuit consisting of the power supply and the solenoid shorted by the ESTS. The circuit equation for the system is

$${L}_{T} ( z ) \frac{{d}^{2} I}{d {t}^{2}} + \frac{I}{C} = 0 , \qquad ( 1 )$$

where L_{T} (z) is the total inductance of the system, and I is the current flowing down the solenoid. Let dL₀/dz be the inductance of the solenoid per unit axial length, and then the total inductance can be expressed as

$${L}_{T} ( z ) = L + ( \frac{d {L}_{0}}{d z} ) z , \qquad ( 2 )$$

where we have assumed that the solenoid starts at z=0 and z is the axial position of the center of the ESTS. The equation of center-of-mass motion of the ESTS can be derived from magnetohydrodymanics (MHD) (Schmidt, 1979). To summarize, the self-consistent equations governing the ESTS acceleration are

$$\begin{matrix}{L}_{T} ( z ) \frac{{d}^{2} I}{d {t}^{2}} + \frac{I}{C} = 0 , & ( 3 ) \\ {L}_{T} ( z ) = L + ( \frac{d {L}_{0}}{d z} ) z , & ( 4 ) \\ M \frac{{d}^{2} z}{d {t}^{2}} = \frac{1}{2} ( \frac{d {L}_{0}}{d z} ) {I}^{2} , & ( 5 )\end{matrix}$$

where M is the ESTS mass. These coupled equations can be solved simultaneously to predict the trajectory of the ESTS. It should be noted that equations (3)-(5) have the same form as those obtained and verified (Hammer, et al., 1988) for the compact toroid accelerator reported by (Hammer, et al., 1988; Degnan, et al., 1993; Kiuttu, et al., 1994).

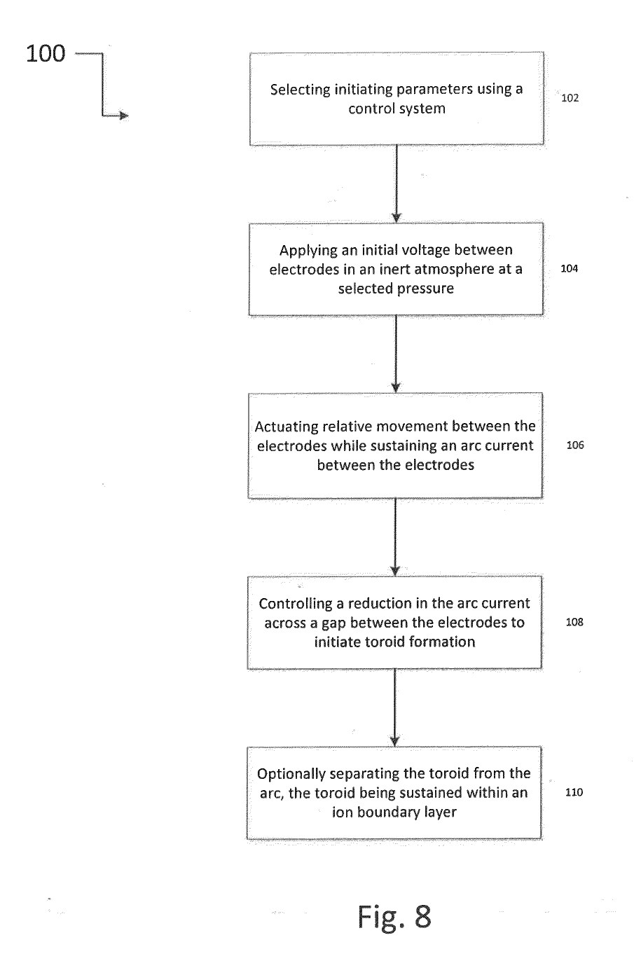

Illustrated in FIG. 8 is a process sequence 100 in which a programmable control system is used to initiate a toroid. Software is used to issue instructions to system components to control timing of arc formation. The process is initiated when the user selects parameters 102 such as electrode spacing separation velocity, gas pressure and initiating voltage 104. Actuators are instructed to provide for movement 106 of one or both electrodes to increase the gap. The arc current is reduced or attenuated in a controlled manner such that a toroid forms 108. The toroid can optionally be removed 110 from the arc by selective modulation of the arc and magnetic field conditions. The toroid formation process can optionally be repeated as described herein. It will be appreciated by those skilled in the art that modifications to and variations of the above-described systems and methods and equivalents thereof may be made without departing from the inventive concepts disclosed herein. Accordingly, the disclosure should not be viewed as limited except as by the scope and spirit of the appended claims.

What is claimed is:

1) A system for generating a toroidal flow of electrons around an electric arc comprising:
a housing to regulate gas pressure, the housing including a chamber;
a first electrode spaced from a second electrode by a selected separation distance within the chamber;
an actuator to provide relative movement between the first electrode and the second electrode to control the separation distance;
a power source to apply a controlled electric voltage across the separation distance to generate an electric arc;
a controller to adjust the electric voltage across the separation distance, the controller being connected to the actuator to adjust the separation distance between the first electrode and the second electrode to initiate a toroidal flow of electrons around the arc; and
a background gas to supply a source of ions within the chamber.

2) The system of claim 1 wherein the actuator comprises a motor.

3) The system of claim 1 wherein the actuator moves at least one of the first electrode and second electrode from an arc ignition position to an operating position.

4) The system of claim 1 wherein the electric voltage across the arc path is modulated from an initial arc voltage to an operating arc voltage to generate a toroid of electrons about the electric arc.

5) The system of claim 3 wherein the separation distance is in a range of 0-30 mm in the ignition arc position and the separation distance is in a range of 30-150 mm in the operating position.

6) The system of claim 1 wherein the chamber is connected to a vacuum pump and an inert gas source.

7) The system of claim 1 wherein the actuator is connected to a first cable attached to the first electrode and further connected to a second cable attached to the second electrode.

8) The system of claim 1 wherein the controller comprises a computer having a memory, the memory storing operating parameters of the system, the operating parameters including a separation velocity.

9) The system of claim 1 further comprising an accelerator to actuate movement of an electron toroid generated by an electric arc between the first electrode and the second electrode.

10) The system of claim 9 wherein the accelerator comprises a magnet coil assembly.

11) A method for generating a toroidal flow of electrons around an electric arc comprising:
regulating gas pressure within a chamber;
applying a controlled electric voltage across a separation distance between a first electrode and a second electrode to generate an electric arc; and
adjusting the electric voltage across the separation distance with a controller to generate a toroidal flow of electrons around the arc.

12) The method of claim 11 further comprising actuating relative movement between the first electrode and the second electrode with an actuator.

13) The method of claim 12 further comprising actuating said movement with a motor.

14) The method of claim 11 further comprising moving at least one of the first electrode and second electrode from an arc ignition position to an operating position.

15) The method of claim 11 further comprising increasing electric voltage across the arc path increases from an initial arc voltage to an operating arc voltage.

16) The method of claim 15 further comprising subsequently decreasing the operating voltage.

17) The method of claim 15 wherein the separation distance is in a range of 0-30 mm in the ignition arc position and the separation distance is in a range of 30-150 mm in the operating position.

18) The method of claim 11 further comprising controlling pressure in the chamber with a vacuum pump and an inert gas source.

19) The method of claim 11 further comprising controlling electrode operation with a computer having a memory, the memory storing operating parameters of the system, the operating parameters including a separation velocity.

20) The method of claim 11 further comprising generating a plurality of toroids around the arc formed across the separation distance.

21) The method of claim 11 further comprising accelerating an electron toroid to move the electron toroid towards a target.

22) The method of claim 11 further comprising actuating a magnet coil assembly to move an electron toroid generated by an arc extending between the first electrode and the second electrode.

23) The method of claim 20 further comprising modulating the arc voltage to generate the plurality of toroids.

24) The method of claim 11 further comprising decreasing the operating voltage as the separation distance increases.

25) The method of claim 11 further comprising adjusting the electric voltage with a voltage control device.
